(19) United States
(12) Patent Application Publication
(10) Pub. No.: US 2018/0121856 A1
(43) Pub. Date: May 3, 2018

(54) FACTOR-BASED PROCESSING OF PERFORMANCE METRICS

(71) Applicant: LinkedIn Corporation, Sunnyvale, CA (US)

(72) Inventors: Yongling Song, Dublin, CA (US); Brent D. Miller, Sunnyvale, CA (US); Andrew J. Carter, Mountain View, CA (US); Swee B. Lim, Cupertino, CA (US)

(73) Assignee: LinkedIn Corporation, Sunnyvale, CA (US)

(21) Appl. No.: 15/342,834

(22) Filed: Nov. 3, 2016

(51) Int. Cl. G06Q 10/06

(52) U.S. Cl. CPC G06Q 10/06393

(57) ABSTRACT

The disclosed embodiments provide a system for processing data. During operation, the system obtains, for a time interval, a set of performance metrics for one or more monitored systems. Next, the system aggregates the performance metrics by a processing factor associated with execution of the monitored system(s). The system then uses the aggregated performance metrics to calculate a performance score associated with the processing factor. Finally, the system outputs the performance score with other performance scores for other performance factors associated with execution of the one or more monitored systems for use in assessing the performance of the monitored system(s).

### BACKGROUND

### Field

The disclosed embodiments relate to performance metrics for monitored systems. More specifically, the disclosed embodiments relate to techniques for performing factor-based processing of performance metrics.

### Related Art

Web performance is important to the operation and success of many organizations. In particular, a company with an international presence may provide websites, web applications, mobile applications, databases, content, and/or other services or resources through multiple data centers around the globe. An anomaly or failure in a server or data center may disrupt access to a service or a resource, potentially resulting in lost business for the company and/or a reduction in consumer confidence that results in a loss of future business. For example, high latency in loading web pages from the company's website may negatively impact the user experience with the website and deter some users from returning to the website.

The distributed nature of web-based resources may complicate the accurate detection and analysis of web performance anomalies and failures. For example, the overall performance of a website may be affected by the interdependent execution of multiple services that provide data, images, video, user-interface components, recommendations, and/or features used in the website. As a result, aggregated performance metrics such as median or average page load times and/or latencies in the website may be calculated and analyzed without factoring in the effect of individual components or services on the website's overall performance.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows the processing of performance metrics for a monitored system in accordance with the disclosed embodiments.

FIG. 4 shows a flowchart illustrating the processing of data in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

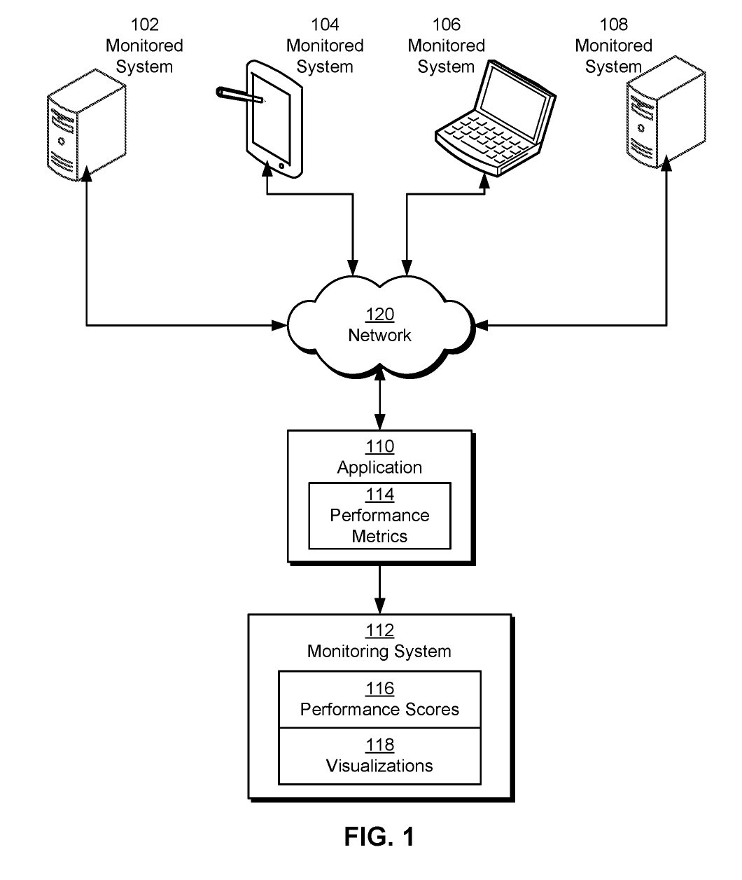

The disclosed embodiments provide a method, apparatus, and system for processing data. More specifically, the disclosed embodiments provide a method, apparatus, and system for analyzing performance data collected from a monitored system. As shown in FIG. 1, a monitoring system 112 may monitor one or more performance metrics 114 related to access to an application 110 by a number of monitored systems 102-108. For example, the application may include a web application, one or more components of a mobile application, one or more services, and/or another type of client-server application that is accessed over a network 120. In turn, the monitored systems may be personal computers (PCs), laptop computers, tablet computers, mobile phones, portable media players, workstations, servers, gaming consoles, and/or other network-enabled computing devices that are capable of executing the application in one or more forms.

During access to application 110, monitored systems 102-108 may provide performance metrics 114 to the application and/or monitoring system 112 for subsequent analysis by the monitoring system. For example, a computing device that retrieves one or more pages (e.g., web pages) or screens of the application over network 120 may transmit load times of the pages or screens to the application and/or monitoring system.

In addition, one or more monitored systems 102-108 may be monitored indirectly through performance metrics 114 reported by other monitored systems. For example, the performance of a server and/or data center may be monitored by collecting page load times, latencies (e.g., network latencies, processing latencies, operational latencies, response times, etc.), error rates (e.g., percentage of errors during processing of database queries, synchronization of data, transmission of data, etc.), and/or other performance metrics from client computer systems, applications, and/or services that request pages, data, and/or application components from the server and/or data center.

Performance metrics 114 from monitored systems 102-108 may be aggregated by application 110 and/or other monitored systems, such as one or more servers used to execute the application. The performance metrics may then be provided to monitoring system 112 for the calculation of performance scores 116 and/or the generation of visualizations 118 containing the performance metrics and/or scores, as described in further detail below.

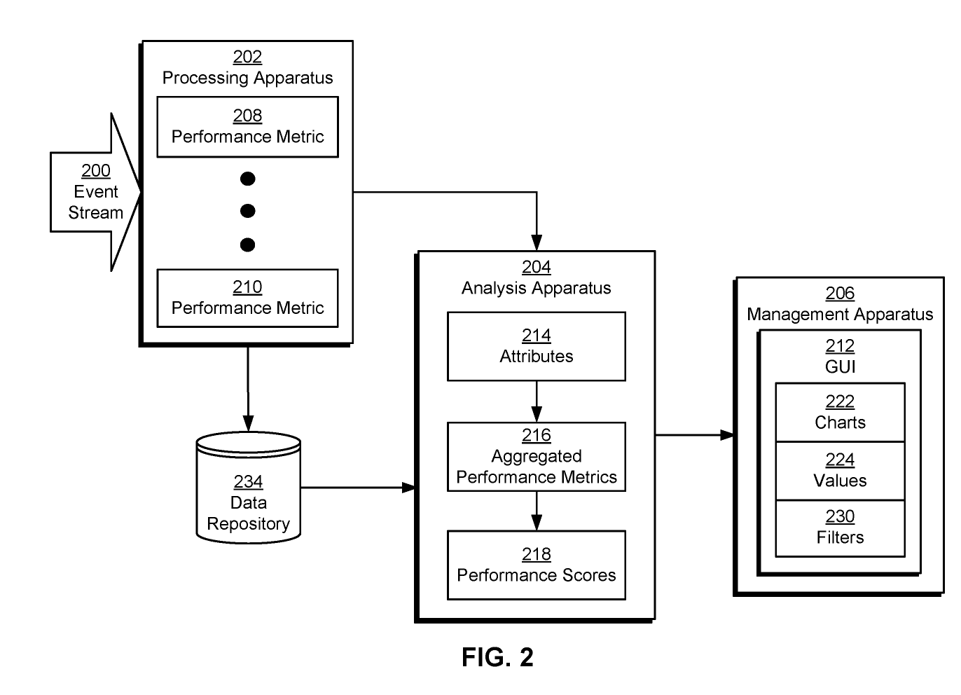

FIG. 2 shows a system for processing data in accordance with the disclosed embodiments. More specifically, FIG. 2 shows a monitoring system, such as monitoring system 112 of FIG. 1, that collects and analyzes performance metrics from a number of monitored systems. As shown in FIG. 2, the monitoring system includes a processing apparatus 202, an analysis apparatus 204, and a management apparatus 206. Each of these components is described in further detail below.

Processing apparatus 202 may obtain a number of performance metrics 208-210 from an event stream 200 containing records of page views, clicks, service calls, and/or other activity collected from monitored systems 102, 104, 106, and 108. Each record may include a page load time, latency, error state, and/or other performance metric associated with the corresponding activity. As a result, processing apparatus 202 may receive large numbers (e.g., thousands) of event records from event stream 200 every second.

In addition, events in event stream 200 may be obtained from multiple sources. For example, records of events associated with use of a website, web application, and/or other client-server interaction may be received from a number of servers and/or data centers hosting the website, which in turn may receive data used to populate the records from computer systems, mobile devices, and/or other electronic devices that interact with the website or web application. The records may be aggregated to event stream 200 for further processing by processing apparatus 202. In turn, processing apparatus 202 may perform grouping, ordering, and/or filtering of the records by subscribing to different types of events in the event stream; aggregating records of events along dimensions such as location, region, event type, service type, and/or time interval; and/or generating summary statistics such as medians, quantiles, variances, means, maximums, minimums, and/or counts from the records and/or corresponding performance metrics 208-210.

In addition, processing apparatus 202 may aggregate events and/or records from event stream 200 in a number of ways. For example, processing apparatus 202 may aggregate sets of a pre-defined consecutive number of page views, page load times, latencies, error rates, and/or other performance metrics 208-210 for a given set of dimensions (e.g., location, region, etc.) into a single aggregated record. Alternatively, processing apparatus 202 may aggregate records received from event stream 200 along pre-specified intervals (e.g., one-minute intervals), independently of the number of events generated within each interval.

Processing apparatus 202 may then store the aggregated records and/or performance metrics 208-210 in a data repository 234, such as a relational database, distributed filesystem, and/or other storage mechanism for subsequent retrieval and use. A portion of the aggregated records and/or performance metrics may be transmitted directly to analysis apparatus 204 and/or another component of the system for real-time or near-real-time analysis by the component.

In one or more embodiments, metrics and dimensions in event stream 200 are associated with user activity at an online professional network. The online professional network may allow users to establish and maintain professional connections; list work and community experience; endorse, follow, message, and/or recommend one another; search and apply for jobs; and/or engage in other professional or social networking activity. Employers may list jobs, search for potential candidates, and/or provide business-related updates to users. As a result, the metrics may track values such as dollar amounts spent, impressions of ads or job postings, clicks on ads or job postings, profile views, messages, job or ad conversions within the online professional network, and so on. In turn, the dimensions may describe attributes of the users and/or events from which the metrics are obtained. For example, the dimensions may include the users' industries, titles, seniority levels, employers, skills, and/or locations. The dimensions may also include identifiers for the ads, jobs, profiles, pages, and/or employers associated with content viewed and/or transmitted in the events. The metrics and dimensions may thus facilitate understanding and use of the online professional network by advertisers, employers, and/or other members of the online professional network.

As mentioned above, the metrics may also include latencies, error rates, and/or other performance metrics 208-210 associated with features or components in a client-server interaction. For example, the performance metrics may be used to track, measure, and/or monitor the performance and/or loads associated with service call processing by application-programming interfaces (APIs) and/or services in the online professional network. Some or all of the monitored APIs and/or services may process queries of a graph database that tracks relationships, interactions, and/or other user activity in the online professional network. In turn, dimensions associated with the metrics may identify services, APIs, clients, query types, query parameters, traffic types, timestamps, batch sizes, responses sizes, and/or other attributes 214 that can be used to group, aggregate, filter, and/or analyze the performance metrics.

Moreover, performance metrics 208-210 related to a website, web application, mobile application, service, API, and/or other network-based application or component used to access the online professional network may be used by developers, administrators, and/or other users associated with creating and maintaining the application or component to identify issues and/or anomalies with the performance. For example, page load times, latencies, error rates, and/or other time-series or aggregated performance metrics in event stream 200 may be analyzed to assess the performance of the corresponding monitored systems, identify factors that may affect the performance, and/or generate alerts that can be used to remedy anomalies and/or reduced performance.

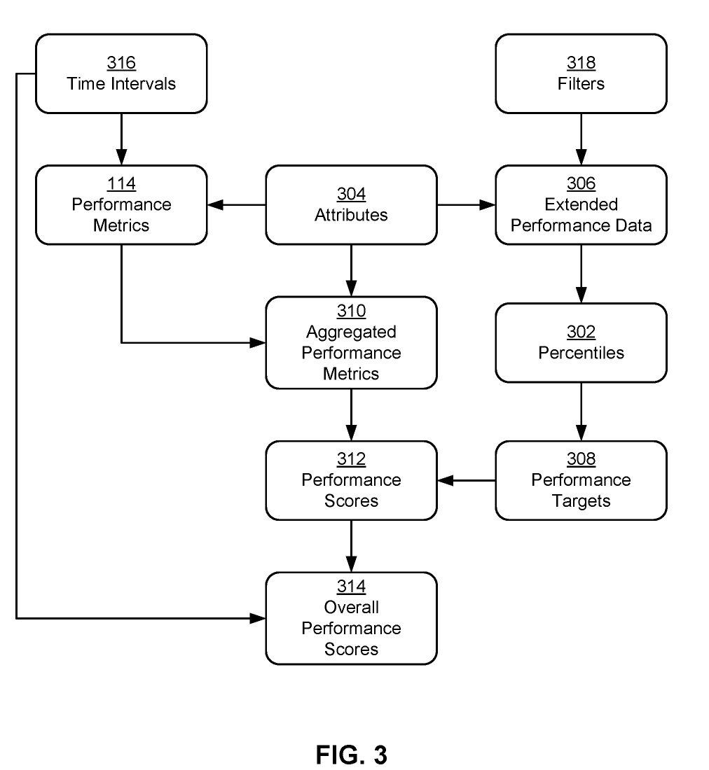

To facilitate analysis of performance metrics 208-210, analysis apparatus 204 may use one or more attributes 214 associated with records in event stream 200 to produce one or more sets of aggregated performance metrics 216. For example, the analysis apparatus may aggregate the performance metrics for a given API, client, service call type, and/or other attribute into one-minute time intervals. As described in further detail below with respect to FIG. 3, analysis apparatus 204 may further aggregate the performance metrics by a processing factor associated with processing performed by the monitored systems, such as a batch size and/or response size associated with service call processing by various components or APIs in an online professional network.

Analysis apparatus 204 may then calculate performance scores 218 for aggregated performance metrics 216 in each time interval to reflect the percentage of performance metrics in the time interval that meet a performance target. By assessing the performance of the monitored systems based on processing factors associated with different types of processing or load on the monitored systems, the analysis apparatus may enable finer-grained analysis of the monitored systems' performance than conventional techniques that do not account for differences in processing and/or execution “cost” in producing or analyzing performance metrics.

After aggregated performance metrics 216 and/or the corresponding performance scores 218 are produced, management apparatus 206 may output one or more representations of the metrics and/or scores in a graphical user interface (GUI) 212. First, management apparatus 206 may display one or more charts 222 in GUI 212. Each chart may include representations of the aggregated performance metrics and/or scores for one or APIs, clients, services, and/or other attributes associated with the performance metrics. For example, the charts may include, but are not limited to, line charts, bar charts, waterfall charts, and/or scatter plots of the performance metrics and/or scores along different dimensions or combinations of dimensions.

Second, management apparatus 206 may display one or more values 224 associated with aggregated performance metrics 216 and/or performance scores 218 in GUI 212. For example, management apparatus 206 may display a list, table, overlay, and/or other user-interface element containing the performance metrics, scores, and associated dimensions.

To facilitate analysis of charts 222 and/or values 224, management apparatus 206 may provide one or more filters 230. For example, management apparatus 206 may display filters 230 for various dimensions and/or attributes 214 along which performance metrics 208-210 are aggregated and/or performance scores 218 are generated. After one or more filters 230 are selected by a user interacting with GUI 212, management apparatus 206 may use filters 230 to update charts 222 and/or values 224. Consequently, the system of FIG. 2 may improve the monitoring, assessment, and management of services and/or other components in client-server interactions.

Those skilled in the art will appreciate that the system of FIG. 2 may be implemented in a variety of ways. As mentioned above, an “online” instance of analysis apparatus 204 may perform real-time or near-real-time processing of events and the corresponding performance metrics 208-210, and an “offline” instance of analysis apparatus 204 may perform batch or offline processing of the events and performance metrics. A portion of analysis apparatus 204 may also execute in the monitored systems to generate aggregated performance metrics 216 and/or performance scores 218, in lieu of or in addition to producing the aggregated performance metrics and/or scores after the corresponding events are received from the monitored systems.

Similarly, processing apparatus 202, analysis apparatus 204, management apparatus 206, GUI 212, and/or data repository 234 may be provided by a single physical machine, multiple computer systems, one or more virtual machines, a grid, a cluster, one or more databases, one or more filesystems, and/or a cloud computing system. Processing apparatus 202, analysis apparatus 204, GUI 212, and management apparatus 206 may additionally be implemented together and/or separately by one or more hardware and/or software components and/or layers.

Moreover, various techniques may be used to obtain performance metrics 208-210 from the monitored systems. For example, the performance metrics may be included in service call tracing data, logs, and/or other mechanisms for tracking the processing and/or activity of the monitored systems, in addition to or in lieu of events in event stream 200. Some or all of the performance metrics may also be obtained from other systems that interact with the monitored systems, such as client computers and/or services that receive query results and/or other data from the monitored systems.

FIG. 3 shows the processing of performance metrics 114 for a monitored system in accordance with the disclosed embodiments. As described above, the performance metrics may include latencies, error rates, and/or other measurements of performance that are collected from and/or associated with a server, data center, computer system, service, API, and/or other monitored system. The performance metrics may be obtained and/or grouped by time intervals 316 within which the corresponding events occurred to produce the performance metrics. For example, latencies and/or error rates of calls to services, APIs, and/or other server-side components of an online professional network may be grouped into one-minute intervals within which the calls were received and/or processed.

Performance metrics 114 may additionally be aggregated by one or more attributes 304 to produce one or more sets of aggregated performance metrics 310. The attributes may include processing factors that are used to differentiate between processing and/or execution types, loads, “costs,” and/or other factors in the monitored systems. For example, the processing factors may include batch sizes (e.g., number of batched calls in a single call) and/or responses sizes (e.g., number of results and/or bytes returned in a response to the call) of service calls in client-server interactions, which in turn may affect the latencies and/or other performance metrics associated with the monitored systems.

Batch sizes, response sizes, and/or other processing factors used to aggregate performance metrics 114 may also be bucketized into ranges of values. For example, the processing factors may be divided into “small,” “medium,” and “large” buckets of batch sizes, with the “small” bucket encompassing batch sizes ranging from 0 to 2, the “medium” bucket encompassing batch sizes ranging from 3 to 25, and the “large” bucket encompassing batch sizes that are greater than 25. Ranges of processing factors associated with the buckets may additionally be set and/or adjusted to reflect the distribution of the processing factors and/or associated performance metrics in the monitored system. Continuing with the previous example, the “small” bucket may have batch sizes that are less than the average batch size for the corresponding service calls, the “medium” bucket may have average to 90^{th} percentile (e.g., percentiles 302) batch sizes for the service calls, and the “large” bucket may have greater than 90^{th} percentile batch sizes for the service calls. As another example, the “small” bucket may include small batch sizes of 0 to 2, the “medium” bucket may have batch sizes that are greater than 3 and up to a batch size representing the 50^{th} percentile latency for the service calls, and the “large” bucket may have batch sizes that represent greater than 50^{th} percentile latency for the service calls. Such use of bucketized ranges of values to aggregate performance metrics 310 may increase the number of performance metrics 114 that can be aggregated into each bucket and/or provide a higher-level view of processing and/or performance in the monitored system.

Attributes 304 may also be used to generate aggregated performance metrics 310 along other boundaries. For example, the attributes may include traffic types (e.g., user-driven traffic, automated internal traffic, etc.), APIs, services, clients, processing parameters (e.g., query types, query parameters, request/response types, etc.), and/or other characteristics that may affect processing or performance of the monitored system.

In turn, the performance of the monitored system may be assessed at various granularities by adjusting the aggregation of performance metrics 310 to include or exclude various attributes 304. For example, multiple levels of aggregation with different sets of attributes may be performed to enable calculation of performance scores 312 for different combinations of services, APIs, clients, processing factors, and/or types of processing associated with the monitored system. In turn, the performance metrics may be used to identify individual factors and/or combinations of factors that may affect performance in the monitored system.

More specifically, a set of performance scores 312 for the monitored system may be calculated from aggregated performance metrics 310 and performance targets 308 associated with the corresponding attributes 304. Each performance target may be a threshold for latency, error rate, and/or another performance metric to be met during service call and/or other types of processing in the monitored system. As a result, the performance target may be included in a service level agreement (SLA) for the corresponding service, API, traffic type, and/or other attribute of the monitored system.

In one or more embodiments, performance targets 308 are calculated using extended performance data 306 for the monitored system. The extended performance data may include a larger set of performance metrics 114 over a wider interval of time to account for changes in capacity (e.g., server capacity) in the monitored system. For example, the extended performance data may include two to three months of historic latencies, error rates, and/or other performance metrics from the monitored system and/or similar systems (e.g., servers, data centers, etc.). To allow the performance targets to reflect current execution and/or processing conditions, the performance targets may be adjusted periodically and/or based on factors such as expected development, changes in capacity, and/or changes in demand.

Extended performance data 306 used to calculate a given performance target may be grouped and/or aggregated by the same attributes 304 as aggregated performance metrics 310 associated with the performance target. For example, a performance target for a latency of a service call associated with a specific API, client, and batch size may be calculated using extended performance data for the same API, client, and batch size. Thus, a “custom” performance target for a given set of processing factors (e.g., batch size, API, client, load, response time, etc.) may be calculated using extended performance data 306 that conforms to the same processing factors.

One or more filters 318 may also be applied to extended performance data 306 prior to calculating performance targets 308. For example, the filters may be used to remove, from the extended performance data, spikes in latency and/or error rate that are associated with failures and/or anomalies in the monitored system instead of regular traffic and/or processing in the monitored system. Such failures and/or anomalies may be identified using alerts and/or notifications from the monitored system and/or mechanisms for assessing the operation of the monitored system. The failures and/or anomalies may also, or instead, be detected by using a hypothesis test and/or other statistical-analysis technique to compare the extended performance data with baselines values to identify statistically significant deviations in the extended performance data from the baseline values.

After extended performance data 306 is aggregated and/or filtered, the corresponding performance targets 308 may be calculated using percentiles 302 associated with the extended performance data. For example, 50^{th} and/or 99^{th} percentile values of latency and/or error rate may be calculated for various time intervals 316 (e.g., one-minute intervals) within the wider time interval spanned by extended performance data 306. The highest or “peak” value for each percentile in the wider time interval may then be used as a performance target for the corresponding aggregated performance metrics 310. The “peak” value may also, or instead, be padded by an extra 10% to obtain the performance target.

Performance scores 312 may then be calculated based on the percentage of aggregated performance metrics 310 that meet the corresponding performance targets 308 within a given time interval (e.g., one-minute interval). For example, a performance metric that meets or satisfies (e.g., falls below) a corresponding performance target may be assigned a value of 1, while a performance metric that does not meet or satisfy (e.g., exceeds) the performance target may be assigned a value of 0. Values assigned to all aggregated performance metrics in the time interval may then be summed and divided by the total number of performance metrics in the same time interval to obtain the percentage of aggregated performance metrics that meet the performance target.

For example, a time interval may include three batched service calls. The first service call may meet the performance target, the second service call may fail to meet the performance target, and the third service call may meet the performance target. As a result, the proportion of performance metrics that meet the performance target may be calculated as (1*1+1*0+1*1)/3, or 66.67%.

The calculated percentages may then be compared with the percentile ranks of the corresponding performance targets 308 to produce performance scores 312. For example, a performance target that is calculated from the 50^{th} percentile value in extended performance data 306 may produce a performance score of 1 if at least 50% of service calls and/or other processing in a given time interval meet the performance target and a performance score of 0 otherwise. Similarly, a performance target that is calculated from the 99^{th} percentile value in the extended performance data may produce a performance score of 1 if at least 99% of service calls and/or other processing in a given time interval meet the performance target and a performance score of 0 otherwise.

Finally, performance scores 312 for a number of time intervals 316 may be aggregated into overall performance scores 314 for longer time intervals. Continuing with the previous example, performance scores for a given set of aggregated performance metrics may be summed over the course of a day and divided by the total number of aggregated performance metrics and/or associated service calls or events over the day to produce an overall performance score for the day. Thus, performance scores for a given batch size, client, API, and/or other attributes 304 associated with a set of aggregated performance metrics 310 that total 15,000 over the day may be divided by a total number of 20,000 service calls associated with the same attributes to obtain an overall performance score of 0.75 for the monitored system represented by the attributes.

After performance scores 312 and overall performance scores 314 are produced, the scores and/or associated aggregated performance metrics 310 may be outputted for use in assessing the performance of the monitored system. As discussed above, the scores and/or metrics may be displayed in one or more charts, tables, and/or other graphical representations of performance of the monitored system within a GUI, such as GUI 212 of FIG. 2. The scores and/or metrics may also be included in reports and/or alerts that are generated on a periodic basis and/or when the performance of the monitored system falls below a threshold. In turn, developers and/or administrators associated with the corresponding API, client, service, and/or another component representing the monitored system may use the scores and/or metrics to identify and mitigate anomalies and/or aberrations in the performance of the monitored system.

The scores and/or metrics may additionally be used to dynamically adjust the processing and/or execution of the monitored system. For example, the generation of performance scores 312 that indicate a failure to meet the SLA may trigger the scaling back of service calls and/or other traffic to the monitored system. In another example, low performance scores and/or overall performance scores 314 associated with a specific client may result in the blocking or throttling of service calls from the client to the monitored system until the performance issue is resolved.

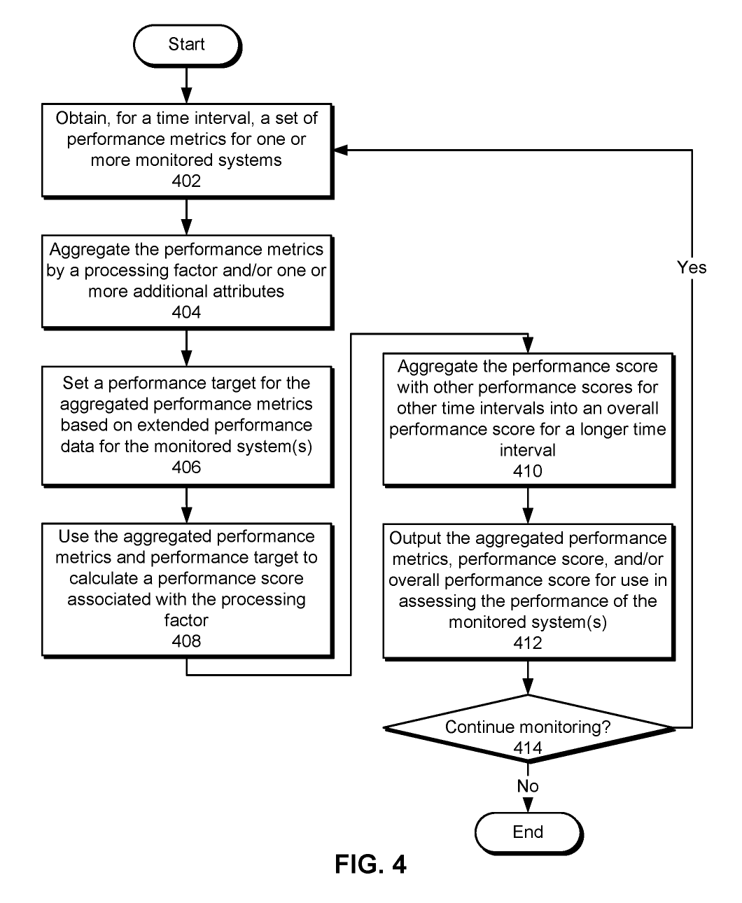

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

Initially, a set of performance metrics for one or more monitored systems is obtained for a time interval (operation 402). For example, latencies, error rates, and/or other measurements of performance for services, APIs, and/or other server-side components of an online professional network and/or other client-server interaction may be grouped into one-minute intervals. Next, the performance metrics are aggregated by a processing factor and/or one or more additional attributes (operation 404). For example, the performance metrics may be aggregated by processing factors such as individual and/or bucketized batch sizes and/or response sizes. The performance metrics may also be aggregated by attributes such as client, API, and/or processing parameters (e.g., query parameters, query types, traffic types, etc.) associated with the monitored system(s).

A performance target for the aggregated performance metrics is also set based on extended performance data for the monitored system(s) (operation 406). For example, the extended performance data may be obtained by aggregating historic performance metrics along the same attributes. The historic performance metrics may span an extended period that accounts for changes in capacity, demand, and/or development in the monitored system(s). The historic performance metrics may also be filtered to remove performance data associated with anomalies and/or failures in the monitored system(s). In turn, the performance target may be set using a percentile (e.g., 50^{th} percentile, 99^{th} percentile, etc.) calculated from the filtered extended performance data.

The aggregated performance metrics and performance target are then used to calculate a performance score associated with the processing factor (operation 408). For example, the performance score may be calculated based on the percentage of the aggregated performance metrics that meet the performance target and/or the percentile rank used to calculate the performance target. The performance score is further aggregated with other performance scores for other time intervals into an overall performance score for an extended time interval (operation 410). For example, performance scores for one-minute intervals of aggregated performance metrics may be aggregated into an overall performance score that represents the performance of the monitored system(s) over the day.

Finally, the aggregated performance metrics, performance score, and/or overall performance score are outputted for use in assessing the performance of the monitored system(s) (operation 412). For example, the scores and/or metrics may be displayed within a chart, table, and/or other representation in a GUI; included in reports, alerts, and/or notifications; and/or used to dynamically adjust the execution of the monitored systems.

Monitoring using the aggregated performance metrics and scores may continue (operation 414). For example, performance metrics associated with client-server interactions in an online professional network, website, web application, and/or other monitored system(s) may continue to be obtained and/or processed during execution of the monitored system. If monitoring is to continue, performance metrics for the monitored system(s) may be obtained for individual time intervals (operation 402) and aggregated by processing factor and/or additional attributes (operation 404). Performance targets may also be set and used to calculate performance scores and overall performance scores associated with the processing factor (operations 406-410), and the scores and metrics may be outputted to improve monitoring and/or execution of the monitored system(s) (operation 412). Monitoring may thus continue until performance metrics are no longer collected from the monitored system(s).

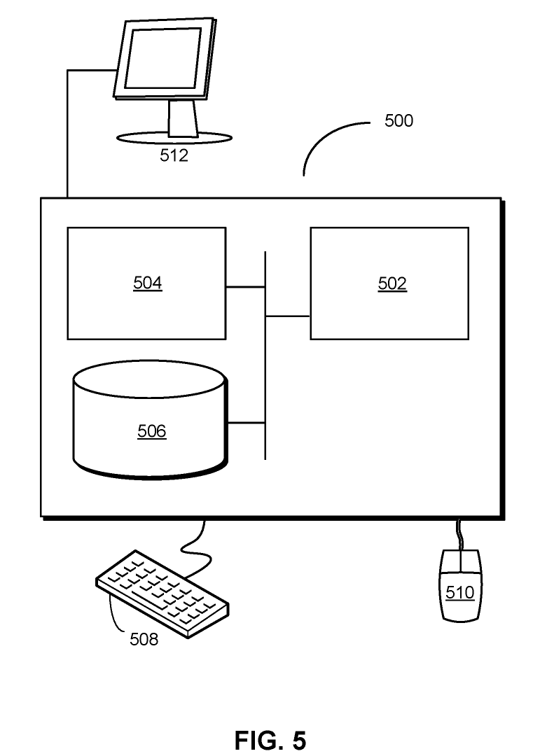

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include an analysis apparatus that obtains, for a time interval, a set of performance metrics for one or more monitored systems. Next, the analysis apparatus may aggregate the performance metrics by a processing factor associated with execution of the monitored system(s). The analysis apparatus may then use the aggregated performance metrics to calculate a performance score associated with the processing factor. The system may also include a management apparatus that outputs the performance score for use in assessing the performance of the monitored system(s).

In addition, one or more components of computer system 500 may be remotely located and connected to the other components over a network. Portions of the present embodiments (e.g., analysis apparatus, management apparatus, processing apparatus, data repository, etc.) may also be located on different nodes of a distributed system that implements the embodiments. For example, the present embodiments may be implemented using a cloud computing system that monitors a set of remote systems for anomalies and/or performance issues and generates output to facilitate assessment and mitigation of the anomalies and/or performance issues.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1. A method, comprising:
obtaining, for a time interval, a set of performance metrics for one or more monitored systems;
aggregating the performance metrics by a processing factor associated with execution of the one or more monitored systems;
using the aggregated performance metrics to calculate, by one or more computer systems, a performance score associated with the processing factor; and
outputting the performance score with other performance scores for other performance factors associated with execution of the one or more monitored systems for use in assessing the performance of the one or more monitored systems.

2. The method of claim 1, further comprising:
setting a performance target for the aggregated performance metrics based on extended performance data for the one or more monitored systems; and
using the performance target to calculate the performance score.

3. The method of claim 2, wherein setting the performance target based on the extended performance data comprises:
setting the performance target using a percentile calculated from the extended performance data.

4. The method of claim 3, wherein setting the performance target based on the extended performance data further comprises:
filtering, from the extended performance data, a subset of the extended performance data associated with anomalies in the one or more monitored systems prior to setting the performance target.

5. The method of claim 2, wherein using the performance target to calculate the performance score comprises:
calculating the performance score based on a percentage of the aggregated performance metrics that meet the performance target.

6. The method of claim 2, further comprising:
aggregating the performance score with additional performance scores for additional time intervals into an overall performance score for an extended time interval comprising the time interval and the other time intervals.

7. The method of claim 1, further comprising:
further aggregating the performance metrics by an additional attribute prior to calculating the performance score.

8. The method of claim 7, wherein the additional attribute comprises at least one of:
a client;
an application-programming interface (API); and
a processing parameter.

9. The method of claim 1, wherein the performance metrics comprise at least one of:
a latency; and
an error rate.

10. The method of claim 1, wherein outputting the performance score for use in assessing the performance of the one or more monitored systems comprises:
displaying the performance score in a chart of a performance of a monitored system.

11. The method of claim 1, wherein the processing factor comprises at least one of:
a batch size; and
a response size.

12. An apparatus, comprising:
one or more processors; and
memory storing instructions that, when executed by the one or more processors, cause the apparatus to:
obtain, for a time interval, a set of performance metrics for one or more monitored systems;
aggregate the performance metrics by a processing factor associated with execution of the one or more monitored systems;
use the aggregated performance metrics to calculate a performance score associated with the processing factor; and
output the performance score with other performance scores for other performance factors associated with execution of the one or more monitored systems for use in assessing the performance of the one or more monitored systems.

13. The apparatus of claim 12, wherein the memory further stores instructions that, when executed by the one or more processors, cause the apparatus to:
set a performance target for the aggregated performance metrics based on extended performance data for the one or more monitored systems;
use the performance target to calculate the performance score; and
aggregate the performance score with additional performance scores for additional time intervals into an overall performance score for an extended time interval comprising the time interval and the other time intervals.

14. The apparatus of claim 13, wherein setting the performance target based on the extended performance data comprises:
filtering, from the extended performance data, a subset of the extended performance data associated with anomalies in the one or more monitored systems; and
setting the performance target using a percentile calculated from the filtered extended performance data.

15. The apparatus of claim 13, wherein using the performance target to calculate the performance score comprises:
calculating the performance score based on a percentage of the aggregated performance metrics that meets the performance target.

16. The apparatus of claim 12, wherein the memory further stores instructions that, when executed by the one or more processors, cause the apparatus to:
further aggregate the performance metrics by an additional attribute prior to calculating the performance score.

17. The apparatus of claim 16, wherein the additional attribute comprises at least one of:
a client;
an application-programming interface (API); and
a processing parameter.

18. The apparatus of claim 12, wherein the processing factor comprises at least one of:
a batch size; and
a response size.

19. A system, comprising:
an analysis module comprising a non-transitory computer-readable medium comprising instructions that, when executed, cause the system to:
obtain, for a time interval, a set of performance metrics for one or more monitored systems;
aggregate the performance metrics by a processing factor associated with execution of the one or more monitored systems; and
use the aggregated performance metrics to calculate a performance score associated with the processing factor; and
a management module comprising a non-transitory computer-readable medium comprising instructions that, when executed, cause the system to output the performance score with other performance scores for other performance factors associated with execution of the one or more monitored systems for use in assessing the performance of the one or more monitored systems.

20. The system of claim 19, wherein the non-transitory computer-readable medium of the analysis module further comprises instructions that, when executed, cause the system to:
set a performance target for the aggregated performance metrics based on extended performance data for the one or more monitored systems;
use the performance target to calculate the performance score; and
aggregate the performance score with additional performance scores for additional time intervals into an overall performance score for an extended time interval comprising the time interval and the other time intervals.
